(19) United States
(12) Patent Application Publication
(10) Pub. No.: US 2003/0172601 A1
(43) Pub. Date: Sep. 18, 2003

(54) Installation of window frames and door frames of synthetic resinous material in concrete

(76) Inventors: Aaron L. Johnson, Vernal, UT (US); Errol L. Johnson, Vernal, UT (US)

Correspondence Address: Mr. Lynn G. Foster, Lynn G. Foster L.C., 602 E. 300 S., Salt Lake City, UT, 84102, US

(21) Appl. No.: 10/098,727

(22) Filed: Mar. 15, 2002

(51) Int. Cl. E06B 1/04; E04G 15/02

(52) U.S. Cl. 52/216; 249/39

(57) ABSTRACT

A concrete for assembly and methodology by which instable window and door frames, placed within but not directly connected to a concrete form, are caused to be stable, position secured and sealed during a concrete pour.

### FIELD OF INVENTION

The present invention relates generally to installation of window and/or door frames in concrete and more particularly to encasement of window frames or door frames made of synthetic resinous material in concrete so that the frames are not deflected, distorted or displaced during the pouring of concrete and are ready for window and door installation when the concrete is set and the concrete forms removed.

### BACKGROUND OF THE INVENTION

Within the known prior art, there have been numerous attempts to provide window and/or door frames that can be encased in concrete by installation within concrete forms. In a typical installation, the frame comprises rigid wood or rigid steel frame members, which are directly connected to the concrete forms. These types of window and/or doorframes are initially expensive and are very time consuming to install.

Accordingly, there is a great need for improvement in the field of window and/or door frames to be located in a concrete wall, to reduce the costs of labor and material.

Thus, there is a great need for a simplified, more economical, and more efficient method for encasement of window frames and/or door frames in concrete.

### BRIEF SUMMARY AND OBJECTS OF THE PRESENT INVENTION

With the foregoing in mind, it is a primary object to overcome or substantially alleviate problems of the prior art in the encasement of window and door frames in concrete.

It is a further important object of the present invention to provide improved window and door frames for encasement in concrete and related methodology.

It is another object of the present invention to provide improved methodology for embedding window and door frames in concrete.

Another valuable object is the provision of a system and methodology for placing window and/or door frames, which might otherwise be deflected, distorted and/or displaced, within a concrete form so as to remain stable during a concrete pour.

Yet another paramount object of the present invention is to provide improved assemblies and methods for installing a synthetic resinous window and/or door frame within a concrete form so as to prevent deflection, distortion, displacement and infiltration of concrete during a concrete pour.

Another significant object of the present invention is to provide improved assemblies and methods for installing window and door frames within a concrete form without direct connection to the concrete form, so that the position is retained during a concrete pour, after which the concrete is easily removed and windows and door readily installed in the frames.

These and other objects and features of the present invention will be apparent from the detailed description taken with reference to accompanying drawings.

### BRIEF DESCRIPTION OF THE DRAWINGS

FIG. 1 is a perspective of the one form of window frame embodying principles of the present invention;

FIG. 2 is a fragmentary cross section taken along line 2-2 of FIG. 1;

FIG. 3 is a fragmentary cross section similar to FIG. 2, but showing the window frame installed in a concrete form;

FIG. 4 is a rear elevational view of the window frame of FIG. 1;

FIG. 5 is a rear elevational view similar to FIG. 5 but with a window assembly installed;

FIG. 6 is a rear elevational view of a door frame embodying principles of the present invention;

FIG. 7 is an enlarged fragmentary cross section taken along line 7-7 of FIG. 6; and

FIG. 8 is an enlarged fragmentary cross section taken along line 8-8 of FIG. 5.

### DETAILED DESCRIPTION OF THE ILLUSTRATED EMBODIMENTS

The present invention is directed to the stabilization of window and door frames to be encased in concrete and sealing of the window and door frames against a concrete form to prevent concrete infiltration during the pour. More specifically, the present invention relates to an assembly and methodology by which window and door frames are placed in a form in sealed relation and thereafter encased or embedded in concrete where the frames are formed of a synthetic resin or other material which is normally position instable, where the frames are not directly connected to the concrete form but are sealed against the form to prevent infiltration of concrete, where the frames are stabilized and do not distort, deflect, displace or unseal during the pouring of concrete and where the frames are ready for window and door installation when the concrete is set and the forms removed. The advantages are an improved product and a significant reduction in costs of labor and materials. The assembly and methodology are simplified when compared to the prior art, making it unnecessary to have highly technically-trained personnel for practicing the invention.

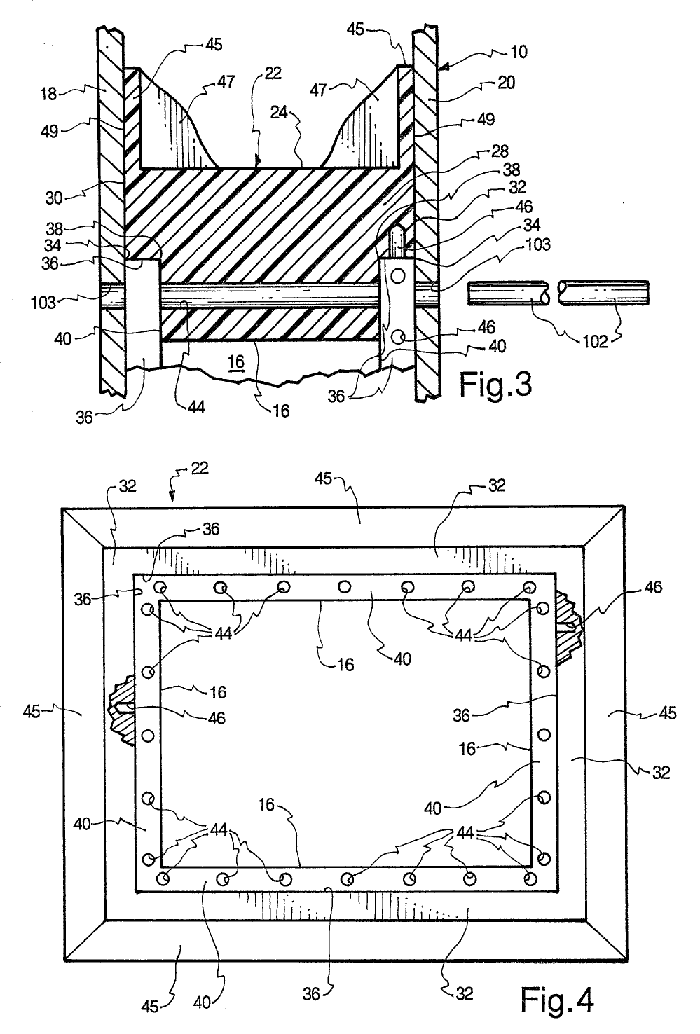

Reference is now made to the drawings, wherein like numerals are used to identify like parts or components throughout. FIG. 3 illustrates an assembly of parts comprising a concrete form, generally designated 10, comprising two spaced concrete form walls 18 and 20, connected together in any conventional way, such as by use of ties, whalers and wedge-shaped retainers. The space between the walls 18 and 20, at the inside surfaces, corresponds to the width of a window frame, formed in accordance with the present invention, which is generally designated 22 in the Figures. The window frame 22 is illustrated as comprising a hollow central region, defined by a bottom, two side and one top wall surfaces, each designated 16. The window frame 22 is illustrated as having been formed as one piece, using conventional molding techniques, from a suitable synthetic resinous material, such as vinyl, which is not per se position stable when under stress caused during a concrete pour.

Essentially the frame 22 comprises a rectangular configuration having four outside surfaces 24, each of which merges at 90 degree outside corners 26 with the next consecutive surface 24. Each surface 24 comprises the outside surface of a wall 28. See FIGS. 2 and 3. The wall 28 comprises continuous front edge surfaces 30, which collectively are rectangular, and continuous rear edge surfaces 32, which collectively are rectangular. The width from surfaces 30 to surfaces 32 is illustrated as being uniform throughout and, as mentioned above, essentially equals the spacing between the interior surfaces of the form walls 18 and 20. See FIG. 3. Thus, when the concrete form assembly 10 is ready to receive a concrete pour, each surface 30 is contiguous with the inside surface of form wall 18 and each surface 32 contiguous with the inside surface of the form wall 20. Surfaces 30 merge through 90 degree corners 34 with shoulder surfaces 36, which collectively form a rectangle. Shoulder surfaces 36 are collectively relatively narrow, are perpendicular to surfaces 30 and merge through 90 degree inside corners 38 with surfaces 40, which collectively form a rectangle. The surfaces 40 are parallel to but offset from surfaces 30. Surfaces 40 merge across outside corners 42 with previously mentioned rectangular surfaces 16. Collectively the four surfaces 16 define the hollow interior within the frame 22 for reception of a window assembly, as explained below.

Reference is now made to FIG. 2, which also shows the back side of the frame 22. Because the configuration of the back of the frame 22 is identical to the configuration of the front, already described, with one exception, identical numerals have been used to avoid excessive and redundant description. The one exception concerns the back rectangular surface 36, which is equipped with an array of spaced blind bores 46, the direction of which is shown to be parallel to surfaces 40.

A plurality or array of throughbores 44 extend in a horizontal direction between the front and back surfaces 40 as shown in FIGS. 2 and 3. These closely spaced throughbores 44 collectively form a rectangular pattern matching the pattern of front and rear surfaces 40 and are used for a purpose yet to be explained.

The frame 22 comprises front and back spaced peripheral flanges 45, which extend outwardly around the front and rear perimeter of the entire frame 22. Each flange 45 is illustrated as being disposed at a camber, identified as angle ∝ in FIG. 2 for purposes yet to be explained. The camber is to be selected by those with skill in the art, but in some instances may provide for an outward camber of each flange 45 on the order of 1/64 of an inch to ¼ of an inch. Each flange is biased toward the outwardly flared position by spaced web supports 47 which bridge between the associated flange 45 and the body 28 of frame material. Each web 47 and the webs 47 collectively not only bias the flanges 45 into the position illustrated in FIG. 2, but continue to bias the associated flange 45 outwardly even when placed within the concrete form 10, as illustrated in FIG. 3. In this way, the flanges 45 not only contiguously engage the inside surfaces of form members 18 and 20, but do so under a compression load which prevents infiltration of concrete along interfaces 49 (FIG. 3), leaving the frame 22 embedded in the concrete, after the pour, where concrete engages only the surfaces 24, the bias webs 47 and the interior surface and peripheral edge of the flanges 45. Accordingly, after the pour, the front and rear faces and hollow interior of the frame 22 will be free of concrete. In other words, the flanges 45 seal tightly against the interior surfaces of the concrete form walls 18 and 20 so as to exclude infiltration of liquid concrete along interfaces 49.

While the peripheral, outwardly extending seal flanges 45 are illustrated as being of uniform thickness, they could be otherwise configured, such as, for example, they could be convergingly tapered from the proximal portion connecting to the body 28 to the distal portion. Likewise, the length of the flanges 45 is not critical, but may be adjusted by those skilled in the art to accomplish the objective, i.e., creation of a compression seal at interfaces 49.

Reference is now made to FIGS. 4, 5 and 8, which illustrate one way a window assembly can be installed contiguously against rear surface 40 and held in that position by strips of trim and screws. More specifically, FIGS. 4, 5 and 8 illustrate a window assembly, generally designated 50, which comprises mitered window frame members 52 having a peripheral outwardly extending flange 54, one surface of which is placed contiguous with rear surface 40 of frame 22. Four strips of mitered trim 56, shown as being wedge-shaped in cross section, are placed over the exposed surface of flange 54 in mitered relation, as best illustrated in FIG. 8, and the trim 56 and flange 54 secured in position by countersunk screws 58 placed in countersunk bores 60 of the trim so as to extend, when tightened into blind bores 46. See FIG. 8. The window assembly 50 comprises a central window pane window 62, held in position, as shown in FIG. 3, by placement in a U-shaped groove 64 of the frame 52, which may be formed of aluminum or other suitable material.

It is to be appreciated that the window assembly 50 shown in FIGS. 3 and 7 is for exemplary purposes only and any desired window assembly could be used and the frame 22 modified in its configuration so as to be able to appropriately receive any appropriately sized window assembly. Furthermore, while the frame 22 is illustrated as being comprised of yieldable synthetic resinous material, other types of synthetic resinous material may be used, as well as composites, aluminum, etc. In addition, while the frame 22 is illustrated and described as being formed of one piece, it could be formed as several pieces and secured together by welding, bonding, use of countersunk fasteners at mitered corners, etc.

Reference is now made to FIGS. 6 and 7, which illustrate a door frame, generally designated 70, fashioned in accordance with principles of the present invention. While the door frame 70 is illustrated as being position instable when placed under loads imposed during a concrete pour and formed of deflectable synthetic resinous material, other suitable materials, as mentioned above, could be used. Again, while the door frame 70 is illustrated as having been formed, using conventional molding techniques, as a single piece, it could be formed of multiple pieces, which are, thereafter, connected together.

The door frame 70 comprises two spaced columns, each generally designated 72, and a top cross beam, generally designated 74. The door frame 70 comprises an exterior perimeter-defining surface 76. Top surface 76 merges with side surfaces 76 at two top outside corners. The door frame 70 comprises a rear face 80 and a front face 82, extending along the three peripheral parts of the frame 70.

Surface 80 merges with shoulder surface 83 at outside corner 85 to form a step or recess. Surface 83 merges at inside corner 87 with a front recessed surface 89. Between surfaces 89 and 82 extend a plurality of spaced throughbores 86. Throughbores 86 are horizontally directed. Three interior surfaces 92 define a hollow interior.

It is intended that a pre-hung door, for example, may be mounted within the hollow interior defined by surfaces 92. A strike plate recess 92 and hinge recess 95 are formed in surfaces 92, to accommodate reception of the pre-hung door. Trim can be added, if desired, in the manner explained above in conjunction with FIGS. 4 and 8 using blind bores 46.

Each column 72 comprises a blunt lower surface-engaging end edge 100, between which a conventional threshold 101 may be placed, before the frame 70 is placed within concrete form 10.

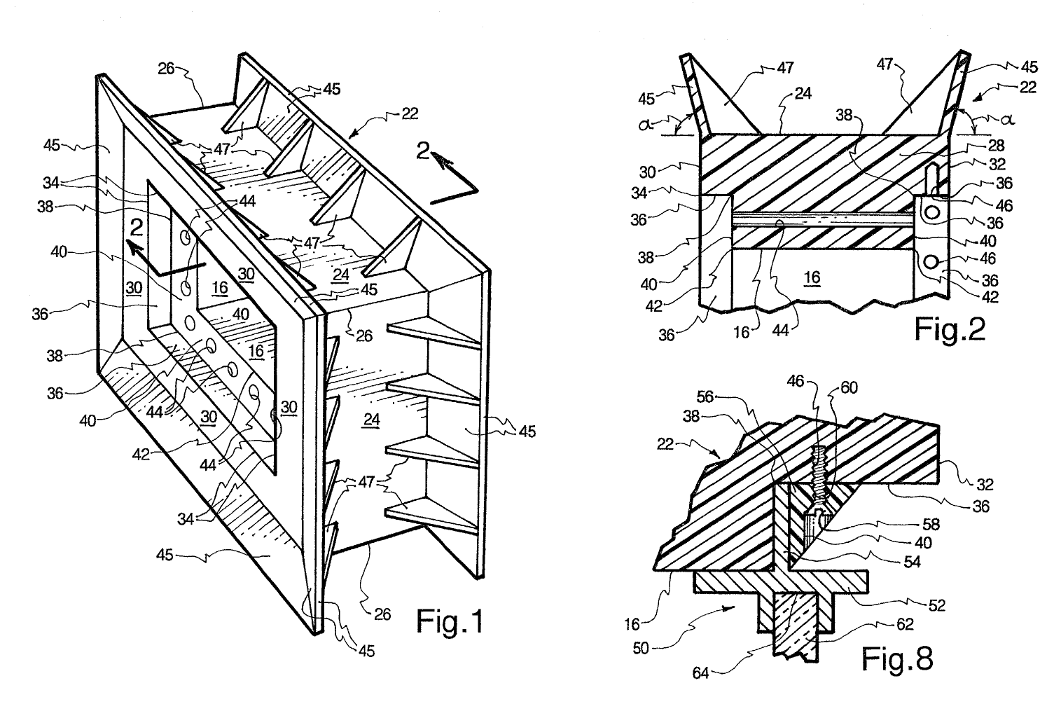

The width of the door frame 70 is selected to be equal to the space between concrete form walls, in the manner shown in FIG. 1.

The above-identified seal flange structure 45 also forms, at the front and back along the three sides of frame 70, the peripherally-defining structure of the frame 70. Bias webs 47 are also utilized. Biased flanges 45 of door frame 70 are constructed and serve the same purpose described above in conjunction with door frame 22. Web bias elements 47 of the frame 70 cause the associated flange 45 to contiguously and compressively engage the interior surfaces of the walls 18 and 20 of the concrete form 10 as explained above. See FIG. 7.

When it is desired to place the window frame 22 within the concrete form 10, one rod 102 is placed through each set of aligned apertures 103 in the walls 18 and 20 and aligned throughbore 44 in frame 22. Each rod 102 is long enough so that it extends beyond each form wall 18 and 20 for sliding manual removal. Once the shaft or distal end of each rod 102 is extended entirely through the associated throughbore 44 and through the apertures 103 in walls 18 and 20, the frame 22 is stabilized against distortion, displacement, and deflection. With the frame 22 in the above described stable position, concrete is poured under, around each side and over the frame 22 to encase or embed the window frame 22 within the concrete around all four surfaces 24 without deflection, distortion or displacement of the frame 22. Also, seal flanges 45 exclude infiltration of wet concrete into the front and rear regions of the frame 22. If desired, concrete may be poured only contiguously against the two side and one bottom surfaces 24, depending on where the frame 22 is placed in the form 10.

After the poured concrete has had sufficient time to set and, preferably, cure somewhat, the rods 102 are removed, and the walls 18 and 20 are disassembled. Thereafter, any exposed apertures 44 may be plugged to improve the appearance and a suitable window assembly installed within frame 22, as explained above.

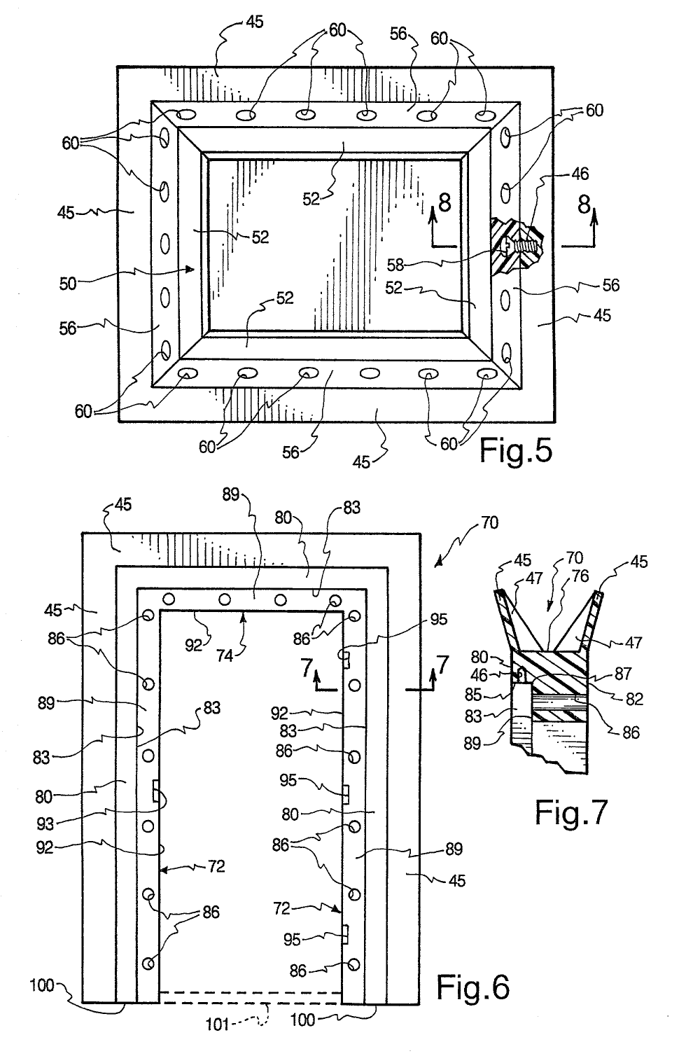

In essentially the same, way, the normally instable frame 70, shown in FIGS. 4 and 5, can be placed within the concrete wall 10 contiguous with the inside surfaces of form walls 18 and 20 with flanges 45 sealing against the inside surfaces of walls 18 and 20 and thereafter, pins 102 inserted through the aligned apertures 103 and throughbores 86. A pre-hung door is later installed in the frame 70, after the concrete is set, the rods 102 removed and the concrete form 10 disassembled.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed and desired to be secured by Letters Patent is:

1. A method of accurately embedding a frame in concrete comprising the acts of:
providing a frame which can be moved when engaged by wet concrete;
placing the frame unattached between spaced walls of a concrete form;
rendering the frame substantially immovable in a desired position in respect to both the concrete form and the wet concrete when poured by placing a plurality of elongated supports through aligned apertures in the form walls and in the periphery of the frame and securing the elongated supports in the placed position;
pouring concrete around the frame;
allowing the concrete to set;
removing the forms and the elongated supports leaving the frame in the desired position in the set concrete.

2. A method according to claim 1 wherein the rendering act renders the frame substantially immovable against at least one of deflection, distortion and displacement.

3. A method according to claim 1 wherein the frame is comprised of synthetic resinous material molded as a single piece with a hollow central interior for receipt of a door or window after the removing act.

4. A method according to claim 1 further comprising the act of mounting a window or a door to the frame after the removing act.

5. A method according to claim 4 comprising the further act of placing trim over the mounting sites.

6. A method according to claim 1 wherein the elongated supports are isolated from the concrete during the pouring act.

7. A method according to claim 1 wherein the elongated supports comprise structural rods having high tensile strength.

8. A method according to claim 1 further comprising the act of sealing the periphery of the frame front and back against the interior of the concrete form before, during and after the pouring act.

9. A method of pouring concrete between form walls around a structurally instable centrally hollow frame for a door or window, comprising the acts of:
extending slender elongated structural members through aligned apertures in the form walls and a periphery of the frame and removably anchoring the slender elongated members in said aperture extending positions to hold the frame in a desired stable position within the form;
pouring concrete into the form around the frame while holding the frame in said desired stable position without material change to the hollow center of the frame;
removing the forms and the slender elongated structural member after the concrete is set leaving the set concrete and the frame exposed;
mounting a door or window to the frame within the hollow center.

10. A method according to claim 9 wherein the frame comprises synthetic resinous material.

11. A method according to claim 10 wherein the synthetic resinous material comprises vinyl.

12. A method according to claim 9 wherein the slender elongated structural members comprise steel rods.

13. An assembly comprising:
spaced walls comprising a concrete form between which concrete is poured;
a structurally instable frame comprising a periphery and a hollow center contiguously engaging and compressively sealing against inside surfaces of the form walls at a desired location;
a plurality of slender elongated structural members passing through aligned apertures at spaced locations in the form walls and in the frame periphery to render the instable frame stable in the desired location before and during the concrete pour.

14. A method of accurately embedding a frame in concrete comprising the acts of:
providing a frame which can be moved when engaged by wet concrete;
placing the frame unattached between spaced walls of a concrete form to create a compressive seal between the periphery of the frame and the interior surfaces of the concrete form;
rendering the frame substantially immovable in a desired position in respect to both the concrete form and the wet concrete when poured by placing a plurality of elongated supports through aligned apertures in the form walls and in the periphery of the frame and securing the elongated supports in the placed position;
pouring concrete around the frame;
allowing the concrete to set;
removing the forms and the elongated supports leaving the frame in the desired position in the set concrete.

15. A method of pouring concrete between form walls around a structurally instable centrally hollow frame for a door or window, comprising the acts of:
extending slender elongated structural members through aligned apertures in the form walls and a periphery of the frame and removably anchoring the slender elongated members in said aperture extending positions to hold the frame in a desired stable position within the form;
compressively sealing a periphery of the frame against interior surfaces of the form walls to prevent concrete infiltration;
pouring concrete into the form around the frame while holding the frame in said desired stable and sealed position, without material change to the hollow center of the frame;
removing the slender elongated structural members and the form walls after the concrete is set, leaving the set concrete and the frame exposed;
mounting a door or window to the frame within the hollow center.
